(19) United States
(12) Patent Application Publication
(10) Pub. No.: US 2009/0260153 A1
(43) Pub. Date: Oct. 22, 2009

(54) CONSTRUCTION OF HOLLOW ZINC DIE-CASTING BY THIXOTROPIC WELDING

(75) Inventor: Kurt J. Thomas, Indianapolis, IN (US)

Correspondence Address: Douglas A. Yerkeson;Baker & Daniels LLP, 300 North Meridian Street, Suite 2700, Indinapolis, IN, 46204, US

(73) Assignee: Masco Corporation of Indiana, Indianapolis, IN (US)

(21) Appl. No.: 12/424,694

(22) Filed: Apr. 16, 2009

Related U.S. Application Data
(60) Provisional application No. 61/124,569, filed on Apr. 17, 2008.

(51) Int. Cl. E03C 1/04; B23K 28/00; B23K 20/10

(52) U.S. Cl. 4/677; 228/176; 228/193; 228/101

(57) ABSTRACT

A method for manufacturing a plumbing fixture by thixotropic welding.

### CROSS-REFERENCE TO RELATED APPLICATION

The present application claims the benefit of U.S. Provisional Patent Application Ser. No. 61/124,569, titled “Construction of Hollow Zinc Die-Casting by Thixotropic Welding,” filed Apr. 17, 2008 by Kurt J. Thomas, Attorney Docket No. DFC-P0109, the disclosure of which is expressly incorporated by reference herein.

### BACKGROUND AND SUMMARY

The present invention relates to construction of a plumbing fixture. More particularly, the present invention relates to construction of a plumbing fixture by thixotropic welding.

Plumbing fixtures such as faucet spouts are often constructed of brass using a removable core casting method. This traditional casting method involves placing sand cores within a metal or sand mold and then pouring or injecting molten brass into the space between the core and mold. The sand cores are then removed by a mechanical means. This traditional casting method possesses several disadvantages. For one, the cycle time is long. Also, there are costs associated with constructing and removing the sand cores.

Another known casting method, known as die-casting, involves injecting molten metal at high speed and high pressure into cavities of a steel mold. The die-casting method presents several advantages over the traditional removable core casting method. For one, the die-casting method typically results in smoother parts with fewer defects than the traditional casting method. Also, since the die-casting process utilizes durable tooling, the process runs automatically and with low scrap. In addition, the die-casting process accommodates often preferred materials. For example, while aluminum, zinc, and magnesium may be used in die-casting processes, separate alloys are typically used for traditional casting processes.

Although the die-casting method presents several advantages over the traditional removable core casting method, the traditional casting method is often preferred when manufacturing hollow parts. Compared to die-casting, the traditional casting method provides more options for the size and shape of the hollow parts. Die-casting processes are often limited to parts having cores with simple shapes.

Another option for manufacturing a hollow part is to produce several pieces and then mechanically assemble those pieces into the final part. However, the final part may have undesirable gaps due to an imperfect assembly. In addition, traditional welding processes, such as brazing, soldering, tungsten inert gas (TIG) welding, metal inert gas (MIG) welding, and electrical arc welding, may be used to assemble the separate pieces but require elevated temperatures which may distort the pieces and cause compatibility issues.

According to an illustrative embodiment of the present disclosure, a method is provided for manufacturing a faucet. The method includes the step of providing a first faucet component and a second faucet component. The first faucet component has a first surface and the second faucet component has a second surface. The method also includes the step of positioning the first faucet component against the second faucet component such that the first surface and the second surface share a common plane. The method further includes the steps of applying a first force of a first magnitude to the first and second faucet components in a direction essentially transverse to the common plane, forcing the first and second surfaces against each other, moving the first surface relative to the second surface while maintaining the first and second surfaces in the common plane, which increases a temperature of the first and second surfaces, and applying a second force of a second magnitude to the first and second faucet components in the direction essentially transverse to the common plane. The second magnitude of the second force illustratively exceeds the first magnitude of the first force. The second force forces the first and second surfaces against each other until the first and second faucet components are welded together.

According to another illustrative embodiment of the present disclosure, a method is provided for manufacturing a plumbing fixture. The method includes the steps of providing a first plumbing component having a first surface and a second plumbing component having a second surface, where the first and second surfaces share a common plane, inducing a vibration along the common plane, and forcing the first surface against the second surface until they become welded together.

According to yet another illustrative embodiment of the present disclosure, a faucet is provided having a first faucet component, a second faucet component, and a waterway between the first and second faucet components. The first faucet component has a first surface, is formed by die-casting, and includes zinc. The second faucet component has a second surface, is formed by die-casting, and includes zinc. The first and second surfaces share a common plane. The waterway is formed by forcing the first surface against the second surface while oscillating the first surface relative to the second surface within the common plane.

### BRIEF DESCRIPTION OF THE DRAWINGS

The above-mentioned and other features and advantages of this invention, and the manner of attaining them, will become more apparent and the invention itself will be better understood by reference to the following description of embodiments of the invention taken in conjunction with the accompanying drawings, wherein:

FIG. 1 is a front elevational view of an illustrative faucet of the present disclosure having a spout;

FIG. 2 is a front elevational view of the spout of FIG. 1 joined and divided along a common plane;

FIG. 3 is a view similar to FIG. 2 with a partial cross-section showing an internal waterway of the spout;

FIG. 4 is a plan view of the spout of FIG. 1;

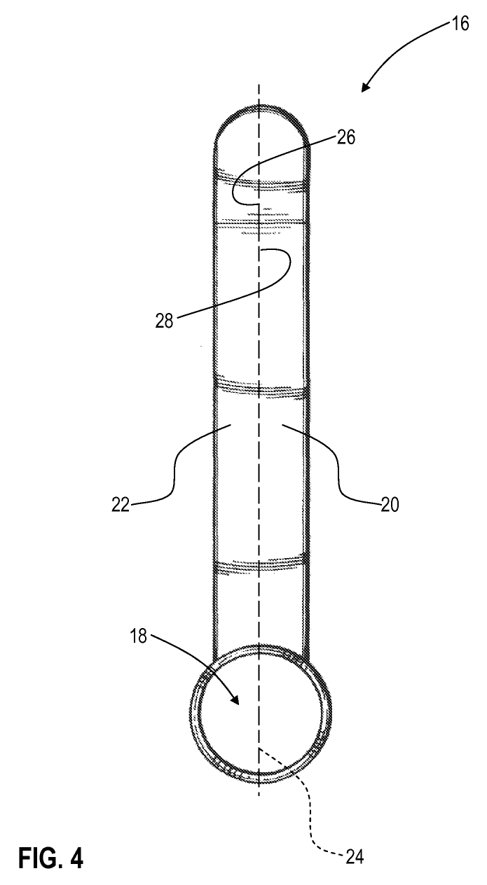

FIG. 5 is a cross-sectional view of a first die and a second die of the present disclosure;

FIG. 6 is a view similar to FIG. 2 illustrating a method of the present disclosure; and

FIG. 7 is a view similar to FIG. 6 illustrating a method of the present disclosure.

Corresponding reference characters indicate corresponding parts throughout the several views. The exemplifications set out herein illustrate exemplary embodiments of the invention and such exemplifications are not to be construed as limiting the scope of the invention any manner.

### DETAILED DESCRIPTION

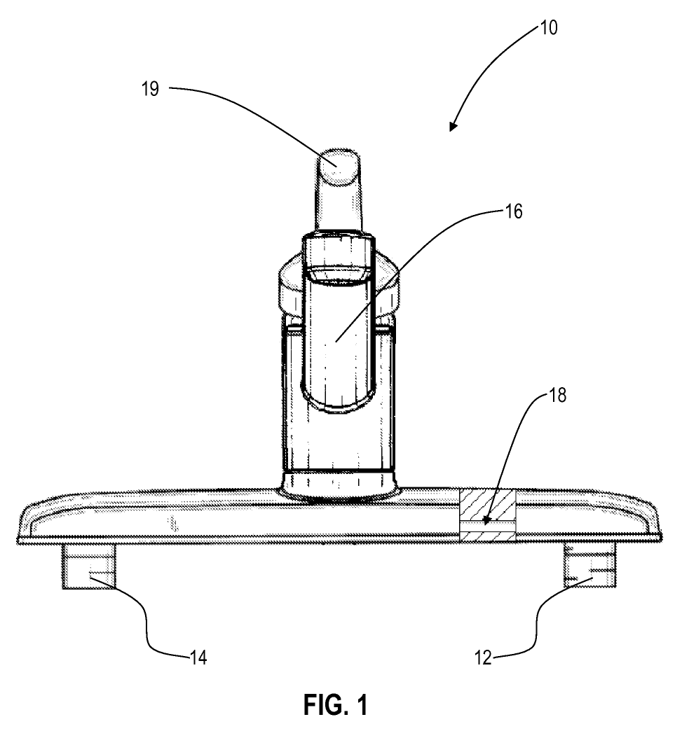

Referring to FIG. 1, an illustrative faucet 10 is provided having hot water inlet 12, cold water inlet 14, spout 16, water passageway or chamber 18, and handle 19. Although faucet 10 is illustrated as having a single handle 19, the present disclosure is applicable to faucets having two handles as well as other plumbing fixtures as further detailed herein. Chamber 18 extends from both hot water inlet 12 and cold water inlet 14 through spout 16. In operation, hot water fed into chamber 18 at hot water inlet 12 and cold water fed into chamber 18 at cold water inlet 14 combine and flow together into chamber 18 of spout 16. From spout 16, the water is discharged into, for example, a kitchen or bathroom sink.

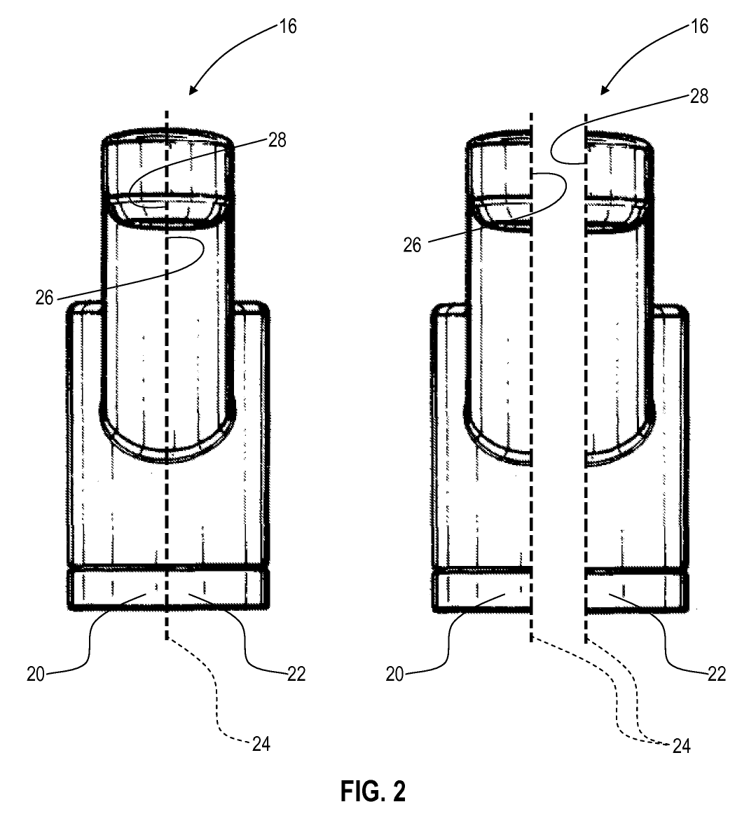

Referring to FIG. 2, the present disclosure involves manufacturing at least two individual pieces of a plumbing fixture, illustratively faucet 10, referred to herein as first faucet component 20 and second faucet component 22. It is within the scope of this disclosure that more than two pieces of the plumbing fixture may be manufactured and combined according to the method set forth herein. First faucet component 20 and second faucet component 22, when joined together, may form an entire plumbing fixture, such as faucet 10, or a portion thereof. For example, first faucet component 20 and second faucet component 22, when joined together, may form spout 16 of faucet 10.

To more fully describe the relationship between first faucet component 20 and second faucet component 22, one can imagine dividing an assembled faucet 10, or a portion thereof, along a plane. This plane is referred to herein as common plane 24. In other words, common plane 24 divides first faucet component 20 from second faucet component 22. The surface of first faucet component 20 located nearest to common plane 24 is referred to herein as first surface 26, while the surface of second faucet component 22 located nearest to common plane 24 is referred to herein as second surface 28. When first surface 26 of first faucet component 20 is aligned with second surface 28 of second faucet component 22, common plane 24 extends there between. At least a portion of first surface 26 and second surface 28 must be located in common plane 24 in order for first faucet component 20 to be attached to second faucet component 22. If common plane 24 divides a solid portion of faucet 10, all of first surface 26 and second surface 28 may be located in common plane 24. However, if common plane 24 divides a hollow portion of faucet 10, such as chamber 18, a portion of first surface 26 and second surface 28 may be located in common plane 24 while a remaining portion of first surface 26 and second surface 28 may extend laterally away from common plane 24. Illustratively, first surface 26 and second surface 28 may be concave, thereby curving away from common plane 24.

According to an exemplary embodiment of the present disclosure, illustrated in FIG. 2, common plane 24 divides faucet 10, or a portion thereof, in half, such that first faucet component 20 and second faucet component 22 form equal halves of faucet 10. More specifically, common plane 24 divides spout 16 in half, such that first faucet component 20 and second faucet component 22 form equal halves of spout 16. In this embodiment, first faucet component 20 is a mirror image of second faucet component 22.

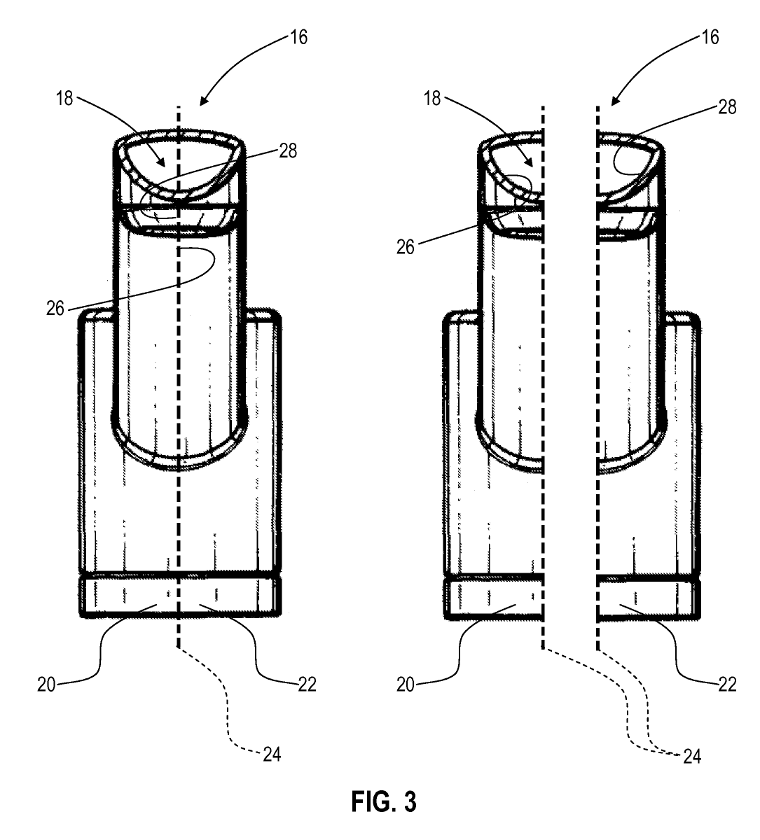

According to another exemplary embodiment of the present disclosure, illustrated in FIG. 3, common plane 24 divides faucet 10 along chamber 18, such that first faucet component 20 and second faucet component 22 both include portions of chamber 18. In this embodiment, a portion of first surface 26 and second surface 28 are located in common plane 24 while a remaining portion of first surface 26 and second surface 28 are concave, curving away from common plane 24. When combined, chamber 18 extends between first faucet component 20 and second faucet component 22.

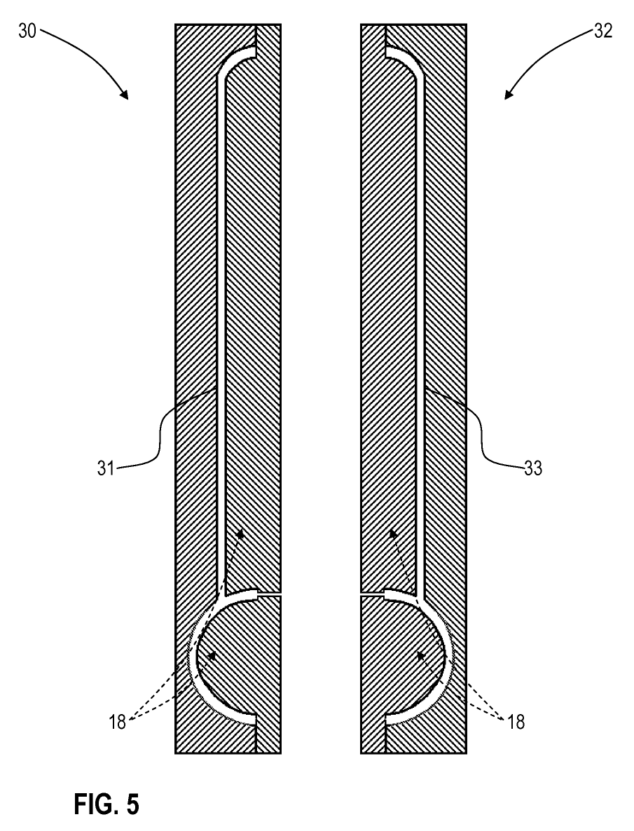

Referring to FIG. 5, molds are illustratively provided for manufacturing first faucet component 20 and second faucet component 22. First die 30 is illustratively a steel mold with inner cavity 31 that matches the shape of first faucet component 20. Similarly, second die 32 is illustratively a steel mold with inner cavity 33 that matches the shape of second faucet component 22. According to the exemplary embodiment of the present disclosure set forth above, in which first faucet component 20 is a mirror image of second faucet component 22, inner cavity 31 of first die 30 is a mirror image of inner cavity 33 of second die 32.

Referring still to FIG. 5, first die 30 and second die 32 are cast with metal to form first faucet component 20 and second faucet component 22, respectively. More specifically, an illustrative method of casting first faucet component 20 and second faucet component 22 involves the following steps. First, a suitable metal is melted. Suitable metals include, without limitation, aluminum, magnesium, zinc, and alloys thereof. However, certain steels having extra lead or sulfur may not be suitable for the welding process set forth below because they may break rather than create friction and heat. First faucet component 20 and second faucet component 22 may be formed of the same or dissimilar materials. Then, the molten metal is injected at high speed and high pressure into inner cavity 31 of first die 30 and inner cavity 33 of second die 32. Once inner cavity 31 of first die 30 and inner cavity 33 of second die 32 are filled, the elevated pressure may be maintained until the molten metal solidifies. Next, first die 30 and second die 32 are opened, and first faucet component 20 and second faucet component 22 are removed. Finally, if necessary, unwanted scrap may be removed from first faucet component 20 and second faucet component 22 by, for example, trimming, polishing, or grinding the parts.

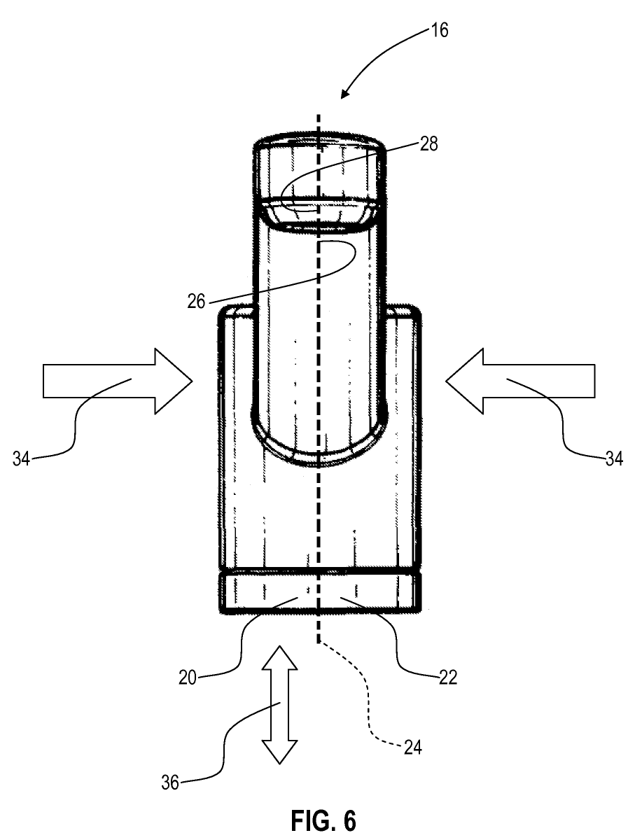

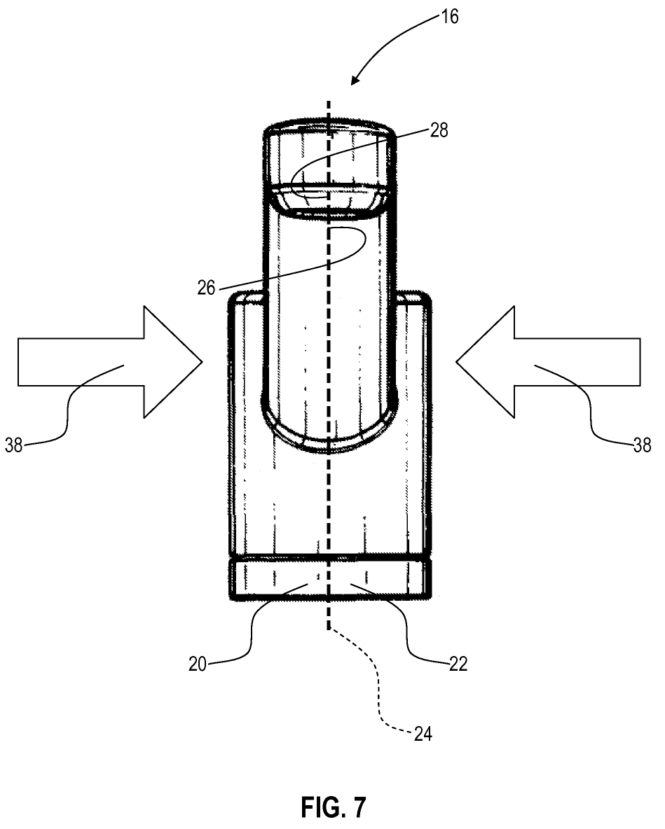

Referring generally to FIGS. 6-7, the present disclosure also involves combining the individual pieces of faucet 10, referred to herein as first faucet component 20 and second faucet component 22, to form faucet 10, or a portion thereof. An exemplary method of the present disclosure involves combining first faucet component 20 and second faucet component 22 by thixotropic welding. Unlike typical welding processes, thixotropic welding involves temporarily disturbing the pieces of faucet 10 enough to attach them together without permanently altering the properties of those pieces.

Referring to FIG. 6, the welding process begins by positioning first faucet component 20 directly against second faucet component 22. More specifically, the welding process begins by positioning first surface 26 of first faucet component 20 directly against second surface 28 of second faucet component 22 such that first surface 26 and second surface 28 share common plane 24. In this position, first faucet component 20 and second faucet component 22 are aligned.

Referring still to FIG. 6, a first force, illustrated schematically by arrows 34, is then applied to first faucet component 20 and second faucet component 22. First force 34 is applied in a direction essentially transverse to common plane 24 to force first surface 26 and second surface 28 together. The magnitude of first force 34 may range from approximately 10 kiloNewtons (kN) to several hundred kiloNewtons (kN). While maintaining first force 34, first surface 26 is moved relative to second surface 28 in a direction essentially parallel to common plane 24, as illustrated schematically by arrow 36. For example, a low amplitude vibration may be induced along common plane 24. The vibration may have a frequency between approximately 50 and 300 Hertz. As another example, first surface 26 may be oscillated relative to a stationary second surface 28. Second faucet component 22 may be clamped in place while first faucet component 20 is oscillated at an amplitude of approximately 1 to 4 millimeters relative to a stationary second surface 28. Movement 36 of first surface 26 relative to second surface 28 causes the temperature of first surface 26 and second surface 28 to increase. Also, the material reaches a thixotropic, semi-molten state, in which the viscosity of both first surface 26 and second surface 28 decreases. The material may reach this thixotropic state within a few seconds, depending on the magnitudes of first force 34 and movement 36.

Referring next to FIG. 7, after first surface 26 and second surface 28 reach a thixotropic state, and before first surface 26 and second surface 28 reach a molten state, movement 36 between first surface 26 and second surface 28 may slow down and/or cease. Then a second force, illustrated schematically by arrows 38, is applied to first faucet component 20 and second faucet component 22. Like first force 34, second force 38 is applied in a direction essentially transverse to common plane 24 to force first surface 26 and second surface 28 together. Second force 38 may be equal or larger in magnitude than first force 34. For example, the magnitude of second force 38 may range from approximately 10 kiloNewtons (kN) to several thousand kiloNewtons (kN). As second force 38 is applied, thixotropic materials from first surface 26 of first faucet component 20 and from second surface 28 of second faucet component 22 intertwine. Second force 38 is applied until the thixotropic materials from first surface 26 and from second surface 28 cool and solidify, welding first faucet component 20 and second faucet component 22 together. By keeping first surface 26 and second surface 28 below a molten state during movement 36 of first surface 26 relative to second surface 28, the properties and integrity of the materials will return to a normal, solid state when welded together.

After first faucet component 20 is welded to second faucet component 22, the part may undergo a finishing process. For example, any undesirable flash that formed between first surface 26 and second surface 28 may be removed. The flash may include debris and dirt carried away from first surface 26 and second surface 28. Also, the part may be buffed, plated, polished, and/or coated.

While this invention has been described as having preferred designs, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method of manufacturing a faucet, comprising the steps of:
providing a first faucet component having a first surface and a second faucet component having a second surface;
positioning the first faucet component against the second faucet component such that the first surface and the second surface share a common plane;
applying a first force of a first magnitude to the first and second faucet components in a direction essentially transverse to the common plane, forcing the first and second surfaces against each other;
moving the first surface relative to the second surface while maintaining the first and second surfaces in the common plane, increasing a temperature of the first and second surfaces; and
applying a second force of a second magnitude, the second magnitude exceeding the first magnitude, to the first and second faucet components in the direction essentially transverse to the common plane, forcing the first and second surfaces against each other until the first and second faucet components are welded together.

2. The method of claim 1, wherein the first faucet component comprises a portion of a spout and the second faucet component comprises a remaining portion of the spout.

3. The method of claim 1, wherein the first and second faucet components comprise essentially equal halves of the faucet.

4. The method of claim 1, wherein the first and second surfaces are at least partially concave.

5. The method of claim 1, wherein the step of positioning the first faucet component against the second faucet component comprises forming a chamber between the first and second faucet components.

6. The method of claim 1, wherein the first and second faucet components comprise zinc.

7. The method of claim 1, wherein the step of providing the first and second faucet components comprises the steps of:
die-casting the first faucet component; and
die-casting the second faucet component.

8. The method of claim 1, wherein the step of moving the first surface relative to the second surface comprises oscillating the first faucet component relative to the second surface.

9. The method of claim 1, further comprising the step of ceasing movement of the first surface relative to the second surface prior to applying the second force.

10. The method of claim 1, wherein the step of applying the second force is performed prior to the temperature of the first and second surfaces reaching a melting temperature.

11. The method of claim 1, further comprising the step of aligning the first surface relative to the second surface prior to applying the second force.

12. The method of claim 1, wherein the step of applying the second force to the first and second faucet components comprises applying the second force until the temperature of the first and second surfaces sufficiently cools.

13. A method of manufacturing a plumbing fixture, comprising the steps of:
providing a first plumbing component having a first surface and a second plumbing component having a second surface, the first and second surfaces sharing a common plane; and
inducing a vibration along the common plane; and
forcing the first surface against the second surface until they become welded together.

14. The method of claim 13, wherein the first plumbing component comprises a portion of a faucet and the second plumbing component comprises a remaining portion of the spout.

15. The method of claim 13, wherein the first plumbing component comprises a portion of a spout and the second plumbing component comprises a remaining portion of the spout.

16. The method of claim 13, wherein the first and second plumbing components comprise zinc.

17. The method of claim 13, wherein the step of providing the first and second plumbing components comprises the steps of:
die-casting the first plumbing component; and
die-casting the second plumbing component.

18. The method of claim 13, wherein the step of forcing the first surface against the second surface comprises the steps of:
applying a first force of a first magnitude to the first and second plumbing components in a direction essentially transverse to the common plane, forcing the first and second surfaces against each other while inducing the vibration along the common plane; and
after applying the first force, applying a second force of a second magnitude until the first and second plumbing components become welded together, the second magnitude exceeding the first magnitude.

19. The method of claim 13, wherein the step of inducing the vibration along the common plane ceases prior to a temperature of the first and second surfaces reaching a melting temperature.

20. A faucet comprising:
a first faucet component having a first surface, said first faucet component formed by die-casting and comprising zinc;
a second faucet component having a second surface, said second faucet component formed by die-casting and comprising zinc, said first and second surfaces sharing a common plane; and
a waterway between the first and second faucet components formed by forcing the first surface against the second surface while oscillating the first surface relative to the second surface within the common plane.

21. The faucet of claim 20, wherein the first faucet component comprises a portion of a spout and the second faucet component comprises a remaining portion of the spout.

22. The faucet of claim 20, wherein the first and second faucet components comprise essentially equal halves of the faucet.

23. The faucet of claim 20, wherein the first and second surfaces are at least partially concave.
